(19) United States
(12) Patent Application Publication
(10) Pub. No.: US 2014/0290381 A1
(43) Pub. Date: Oct. 2, 2014

(54) INTEGRATED ENVIRONMENTAL SENSORS FOR HARSH ENVIRONMENT APPLICATIONS

(71) Applicant: CALIFORNIA INSTITUTE OF TECHNOLOGY, Pasadena, CA (US)

(72) Inventors: Harish Manohara, Glendora, CA (US); Youngsam Bae, West Covina, CA (US); Linda Y. Del Castillo, Irvine, CA (US); Keith B. Chin, Simi Valley, CA (US)

(73) Assignee: CALIFORNIA INSTITUTE OF TECHNOLOGY, Pasadena, CA (US)

(21) Appl. No.: 14/222,507

(22) Filed: Mar. 21, 2014

Related U.S. Application Data
(60) Provisional application No. 61/804,031, filed on Mar. 21, 2013.

(51) Int. Cl. G01F 1/692; G01F 1/56

(52) U.S. Cl. CPC G01F 1/692; G01F 1/56
USPC 73/861.12; 73/204.26

(57) ABSTRACT

Systems and methods in accordance with embodiments of the invention implement integrated environmental sensors that can operate in rigorous environments. In one embodiment, an integrated environmental sensor includes: at least one sensor and a substrate; where: the at least one sensor is disposed on the substrate; the at least one sensor can detect at least two environmental properties including: the surrounding temperature; the surrounding pressure; the flow rate of surrounding fluids; and the surrounding composition; the at least one sensor is capable of detection in an environment that has: a temperature greater than 150° C.; a pressure greater than 100 bar; and/or an inclusion of one of liquid hydrocarbons, H₂S, CO₂, and sulfur species; and the substrate can withstand an environment characterized by at least one of: a temperature greater than 150° C.; a pressure greater than 100 bar; and/or an inclusion of one of liquid hydrocarbons, H₂S, CO₂, and sulfur species.

### CROSS-REFERENCE TO RELATED APPLICATIONS

The current application claims priority to U.S. Provisional Application No. 61/804,031, filed Mar. 21, 2013, the disclosure of which is incorporated herein by reference.

### STATEMENT OF FEDERAL FUNDING

The invention described herein was made in the performance of work under a NASA contract, and is subject to the provisions of Public Law 96-517 (35 U.S.C. §202) in which the Contractor has elected to retain title.

### FIELD OF THE INVENTION

The present invention generally relates to integrated environmental sensors adapted for functionality in rigorous environments.

### BACKGROUND

Sensors that monitor environmental parameters are widely used to enhance the functionality of many engineered structures. For example, temperature sensors are often included within electronic circuitry to help prevent the circuitry from over-heating. Similarly, temperature sensors can also be used to monitor the temperature of an engine (e.g. automobile engine) to also help prevent it from overheating. Pressure sensors and strain gauges can also be used to facilitate the viability of engineered structures. For example, these gauges can measure to what extent a mechanical structure is being stressed and/or strained, and thereby determine whether the structure's failure load is being approached. While pressure, temperature, and strain gauges are known, the present state of the art can benefit from more robust, effective, and versatile environmental sensors that can withstand more rigorous engineering applications.

### SUMMARY OF THE INVENTION

Systems and methods in accordance with embodiments of the invention implement integrated environmental sensors that can provide functionality in rigorous environmental conditions. In one embodiment, an integrated environmental sensor includes: at least one sensor; and a substrate; where: the at least one sensor is disposed on the substrate; the at least one sensor can detect at least two environmental properties that are each one of: the temperature of the environment surrounding the substrate; the pressure of the environment surrounding the substrate; the rate of flow of fluids in the environment surrounding the substrate; and the composition of matter in the environment surrounding the substrate; the at least one sensor is capable of detection in an environment characterized by at least one of: a temperature greater than or equal to approximately 150° C.; a pressure greater than or equal to approximately 100 bar; an inclusion of one of liquid hydrocarbons, H₂S, CO₂, and sulfur species; and the substrate can withstand an environment characterized by at least one of: a temperature greater than or equal to approximately 150° C.; a pressure greater than or equal to approximately 100 bar; an inclusion of one of liquid hydrocarbons, H₂S, CO₂, and sulfur species.

In another embodiment, the at least one sensor is at least two sensors.

In yet another embodiment, the at least two sensors can detect the at least two environmental properties to an accuracy of within approximately 5%.

In still another embodiment, the substrate includes Yttria-Stabilized Zirconia.

In still yet another embodiment, the substrate includes 3 mol % Yttria-Stabilized Zirconia (3YSZ).

In a further embodiment, the substrate is 40 μm in thickness.

In a still further embodiment, the substrate has a surface roughness characterized by 20 nm root mean square, can withstand 800° C., has an ionic conductivity at 800° C. of 0.03 S/cm, and has a strength of 1 GPa.

In a yet further embodiment, at least one sensor is a resistance temperature detector, the resistance temperature detector including a conductive element where the electrical resistance of the conductive element is a function of the temperature of the environment surrounding the substrate.

In a still yet further embodiment, the conductive element of the resistance temperature detector is platinum.

In another embodiment, the platinum has an electrical resistivity of approximately 105 nΩ·m.

In still another embodiment, the resistance temperature detector further includes a protective coating that protects it from the environment surrounding the substrate.

In yet another embodiment, the coefficient of thermal expansion of the substrate and the coefficient of thermal expansion of the resistance temperature detector are sufficiently similar such that the conductive element does not exhibit any stress induced fractures when the temperature surrounding the substrate elevates to 300° C.

In still yet another embodiment, the resistance temperature detector further includes Wheatstone bridge readout circuitry.

In a further embodiment, at least one sensor is a flow rate sensor that can measure the rate of flow of fluids in the environment surrounding the substrate.

In a still further embodiment, the flow rate sensor is a strain gauge-based flow rate sensor that includes a conductive element configured such that when the flow rate sensor is exposed to a flow, the conductive element is strained to an extent that is related to the rate of flow, and the electrical resistance of the conductive element is a function of the extent to which it is strained.

In a yet further embodiment, the substrate is one of: PTFE (Teflon); aluminum; glass; single crystal silicon; Steel; and Inconel; and the conductive element includes one of: metal foil; thin-film metal; single crystal silicon; and polysilicon.

In a still yet further embodiment, the substrate is 3YSZ and the conductive element is platinum.

In another embodiment, the integrated environmental sensor further includes a Wheatstone bridge coupled to the conductive element.

In still another embodiment, the flow rate sensor is a capacitance-based flow rate sensor that includes two electrodes separated by a gap and configured such that when the flow rate sensor is exposed to a flow, the gap distance between the two electrodes changes in relation to the rate of flow, and the capacitance between the two electrodes is a function of the gap distance.

In yet another embodiment, at least one sensor is a composition sensor that can detect the composition of the surrounding environment including two electrodes separated by a gap, where the capacitance between the two electrodes changes as a function of the composition of the gap.

### BRIEF DESCRIPTION OF THE DRAWINGS

FIG. 1 illustrates a wafer including a plurality of integrated environmental sensors having a silicon substrate that includes a passivation layer in accordance with embodiments of the invention.

FIG. 2 illustrates the flexibility of an LCP substrate that can be incorporated in an integrated environmental sensor in accordance with embodiments of the invention.

FIG. 3 illustrates the development of cracks when the CTE of an LCP substrate is not carefully matched to thereon deposited components in accordance with embodiments of the invention.

FIG. 4 illustrates the delamination of components from an LCP substrate when the components are not carefully adhered to the LCP substrate in accordance with embodiments of the invention.

FIG. 5 illustrates the flexibility of a 3YSZ substrate that can be incorporated in an integrated environmental sensor in accordance with embodiments of the invention.

FIG. 6 illustrates flow rate sensors distributed within a pipe in accordance with embodiments of the invention.

FIGS. 7A-7B illustrate a strain gauge-based flow rate sensor that includes a platinum conductive element disposed on a 3YSZ substrate in accordance with embodiments of the invention.

FIGS. 8A-8B illustrate Wheatstone bridges that can be incorporated within an integrated environmental sensor in accordance with embodiments of the invention.

FIG. 9 illustrates a calibration curve of a strain gauge-based flow rate sensor in accordance with embodiments of the invention.

FIG. 10 illustrates a strain gauge-based flow rate sensor including readout circuitry in accordance with embodiments of the invention.

FIGS. 11A-11B illustrate a testing setup to test a strain gauge-based flow-rate sensor in accordance with embodiments of the invention.

FIGS. 12A-12B illustrate capacitance-based flow rate sensors in accordance with embodiments of the invention.

FIG. 13 illustrate a capacitance-based flow rate sensor that incorporates a V-shaped structure in accordance with embodiments of the invention.

FIGS. 14A-14B illustrate additional configurations for a capacitance-based flow rate sensor in accordance with embodiments of the invention.

FIGS. 15A-15C illustrate RTDs including platinum conductive elements disposed on an LCP substrate in accordance with embodiments of the invention.

FIGS. 16A-16B illustrate an RTD including platinum conductive elements disposed on 3YSZ substrate in accordance with embodiments of the invention.

FIG. 17 illustrates coating a sensor in accordance with embodiments of the invention.

FIG. 18 illustrates a strain gauge-based pressure sensor in accordance with embodiments of the invention.

FIGS. 19A-19B illustrate a capacitance-based pressure sensor in accordance with embodiments of the invention.

### DETAILED DESCRIPTION

Turning now to the drawings, systems and methods for implementing integrated environmental sensors that can provide functionality in rigorous environmental conditions are illustrated. In many embodiments, an integrated environmental sensor includes at least one sensor that can detect at least two of the temperature, the pressure, the rate of flow of fluids, and/or the composition of the surrounding environment, and can withstand rigorous environmental conditions that can be characterized by a temperature above 150° C., a pressure greater than or equal to 100 bar, and/or the inclusion of one of liquid hydrocarbons, H₂S, CO₂, and sulfur species. In several embodiments, the integrated environmental sensor includes at least two constituent sensors. In a number of embodiments, the at least one sensor is disposed on a substrate that includes at least one of: 3 mol % Yttria-Stabilized Zirconia and Inconel coated with dielectric material. In several embodiments, the integrated environmental sensor includes a protective coating layer that protects it from the surrounding environment. In many embodiments, the integrated environmental sensor includes a flow rate sensor that can detect the rate of flow of surrounding fluids based on the extent to which the surrounding fluids strain its sensing element. In a number of embodiments, the integrated environmental sensor includes a flow rate sensor that can detect the rate of flow of surrounding fluids based on the extent to which the fluids cause the distance between two electrodes of the sensor to decrease.

While conventional sensors for sensing environmental parameters are known (e.g. resistance temperature detectors), the instant application is directed to integrated environmental sensors that can efficiently provide information regarding the surrounding environment, and can do so even in relatively more extreme environmental conditions. For instance, in many embodiments, an integrated environmental sensor is configured to detect two of: the temperature, the pressure, the rate of flow of surrounding fluids, and/or the composition of the surrounding environment. In this way, the integrated environmental sensors can efficiently provide information, imposing only a small footprint on the environment to be investigated. Importantly, the integrated environmental sensors can be configured to provide functionality in environments where the temperature is greater than or equal to 150° C., where the pressure is greater than or equal to 100 bar, and/or where the environment is corrosive—e.g. includes one of liquid hydrocarbons, H₂S, CO₂, and sulfur species. Thus, in many embodiments, integrated environmental sensors include at least one sensor that can detect at least two properties—e.g. temperature, pressure, rate of flow of surrounding fluids, and/or composition of the surrounding environment—disposed on a substrate, where each of the at least one sensor and the substrate are capable of functionality/operation in an environment where the temperature is greater than or equal to approximately 150° C., where the pressure is greater than or equal to approximately 100 bar, and/or where the environment is corrosive—e.g. includes one of liquid hydrocarbons, H₂S, CO₂, and sulfur species.

In many embodiments, the integrated environmental sensor includes readout circuitry for reading out sensor values. In many instances, the readout circuitry is mounted on the backside of the substrate (e.g. on the side opposite the side where upon the sensors are disposed). Of course, the readout circuitry can be located in any suitable location in accordance with embodiments of the invention. In many instances, each of the sensors that constitute the at least one sensor disposed on a substrate is conductivity based—e.g. it indicates a respective environmental metric based on a corresponding resistance value—or is capacitance-based—e.g. it indicates an environmental metric based on a corresponding capacitance. In this way, the readout circuitry for each of the sensors that constitute the at least one sensor may be consolidated.

The integrated environmental sensors of the instant application can be useful in any of a variety of applications. For example, such integrated environmental sensor may be well suited for implementation within oil pipelines so that oil flow may be characterized and thereby better controlled. Furthermore, in accordance with this application, the integrated environmental sensors may be distributed across many regions of an oil pipeline such that environmental information for each of the many regions can be measured; the distributed integrated sensors may also provide information redundancy in the case of single integrated sensor failures. Of course, it should be understood that the integrated environmental sensors of the instant application can be implemented in any suitable application, and are not limited for implementation in oil pipelines.

Suitable substrate materials upon which at least one sensor can be disposed in accordance with embodiments of the invention are now discussed in greater detail.

### Substrate Materials

In many embodiments, an integrated environmental sensor includes at least one sensor disposed on a substrate that can withstand rigorous environmental conditions. For instance, in many embodiments, the substrate can withstand an environment where the temperature is greater than or equal to approximately 150° C., the pressure is greater than or equal to approximately 100 bar, and/or the environment is corrosive—e.g., includes one of liquid hydrocarbons, H₂S, CO₂, and sulfur species. A robust substrate can allow the integrated environmental sensor to be utilized in more extreme conditions, such as oil pipelines. Additionally, as can be appreciated, the utilized substrate should be compatible with processes that can allow sensors to be disposed on the substrate. Any suitable substrate that is consistent with these criteria can be incorporated within an integrated environmental sensor in accordance with embodiments of the invention. For example, in many embodiments, the substrate upon which at least one sensor is disposed includes one of: silicon with a passivation layer, liquid crystal polymer (LCP) (such as that produced by Rogers Corporation, having an address in 100 S. Roosevelt Avenue, Chandler, Ariz. 85226), 3 mol % yttria-stabilized zirconia (3YSZ) (developed and distributed by ENrG, Inc.—www.enrg-inc.com), and Inconel coated with dielectric.

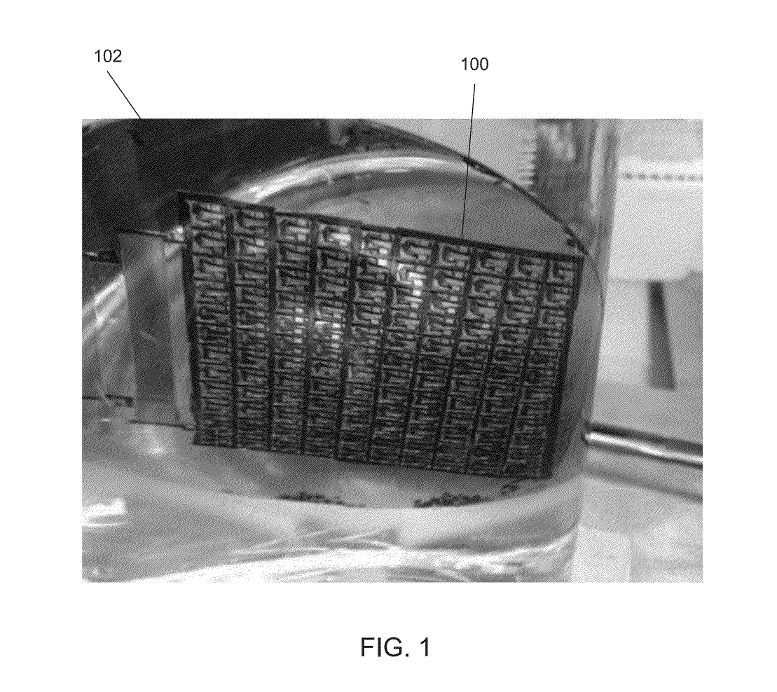

In many embodiments, silicon that includes a passivation layer is used as the substrate upon which at least one sensor is disposed. The passivation layer can help protect the underlying silicon substrate from any deleterious environmental conditions. Using silicon with a passivation layer as the substrate can be advantageous insofar as the corresponding fabrication processes are well-developed. Thus, for example, integrated environmental sensors that incorporate silicon including a passivation layer as a substrate may readily be manufactured in bulk. For example, FIG. 1 depicts the bulk manufacture of integrated environmental sensors that include resistance temperature detectors (RTDs) disposed on a silicon substrate in accordance with embodiments of the invention. In particular, a wafer 100 including a plurality of resistance temperature detectors (RTDs) disposed on a silicon substrate 102 is depicted. The wafer may then be diced to yield the plurality of integrated environmental sensors.

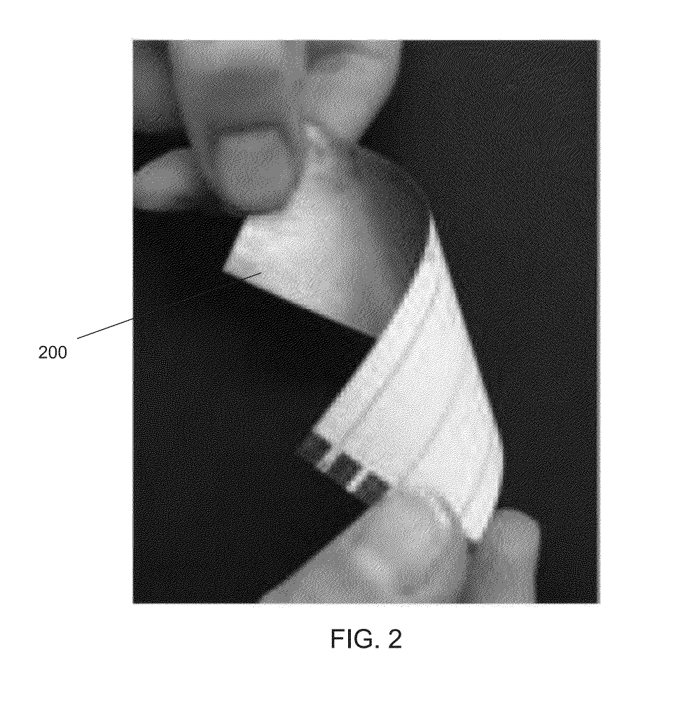

In many embodiments, liquid crystal polymer (LCP) is used as the substrate upon which at least one sensor is disposed. LCP possesses a number of useful properties that indicate its viability for this application. For example, LCP can tolerate temperatures as high as 200° C., can exhibit a dimensional stability of less than 0.1%, and can exhibit a dielectric loss tangent of 0.002 at 20 GHz. Additionally, LCP can be made to be relatively pliable, which can enable implementation in strenuous environmental conditions. Moreover, the flexibility may also be requisite for the operation of some of the sensors that are to be disposed on the substrate (e.g. certain flow rate sensors may require sufficient flexibility for proper operation, as discussed below). FIG. 2 depicts the flexibility that LCP can be made to attain. In particular, an LCP substrate 200 is shown being subjected to substantial strain, yet it still maintains its structural integrity.

Yet another advantage that LCP substrates can confer is that they may be compatible with thermal spray patterning techniques such as those patented and utilized by Mesoscribe, Inc. For example, platinum conductive elements of sensors can be deposited onto an LCP substrate using such techniques; platinum deposited in this manner has been shown to be resistant to minor abrasions. However, in using these thermal spray patterning techniques, care must be taken, as the heat that is locally applied to the substrate during the technique can damage it. While these thermal spray patterning techniques may prove to be challenging to implement, sensor elements (e.g. those constituted of platinum) can be disposed onto the substrate using electron beam-based methods. For instance in many embodiments, the sensor elements are made of platinum that has been disposed on an LCP substrate using electron beam-based methods.

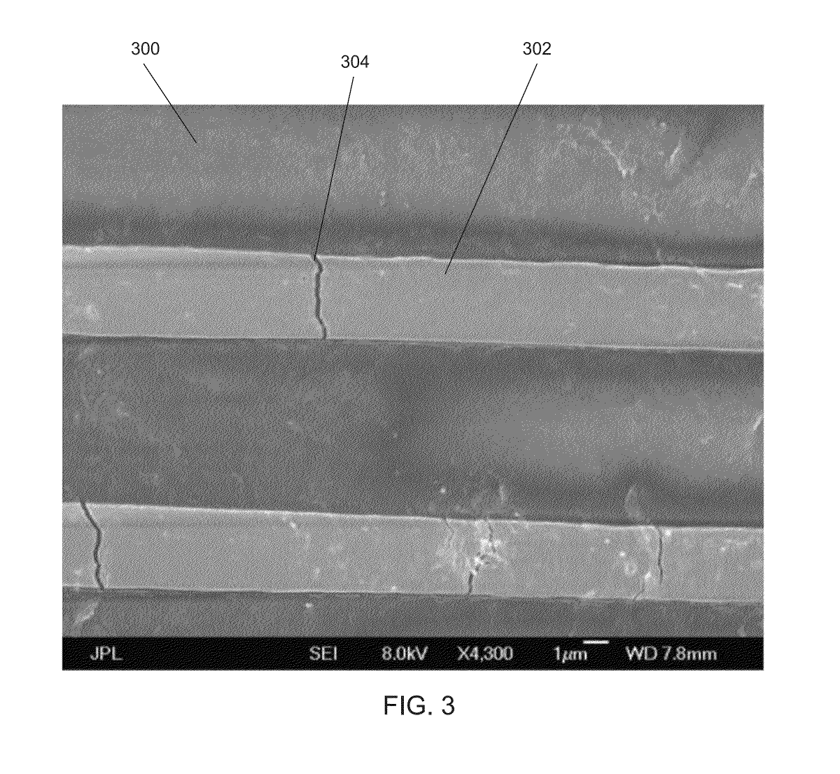

Importantly, using LCP as a substrate material can also be advantageous insofar as the coefficient of thermal expansion (CTE) of LCP can be tailored as desired. Thus, for example, the CTE of the LCP can be made to match that of any sensors, or other components, that are thereon disposed. In this way, instances of the cracking of components during operation may be reduced. For example, FIG. 3 illustrates the consequences of the mismatched CTE as between the LCP substrate and the sensor elements disposed thereon. In particular, platinum conductive elements 302 are depicted as being disposed on an LCP substrate 300. Because of the CTE mismatch between the substrate 300 and the platinum conductive elements 302, cracks 304 are seen to develop. By developing the LCP substrate such that its CTE matches that of elements thereon disposed, such cracking can be avoided.

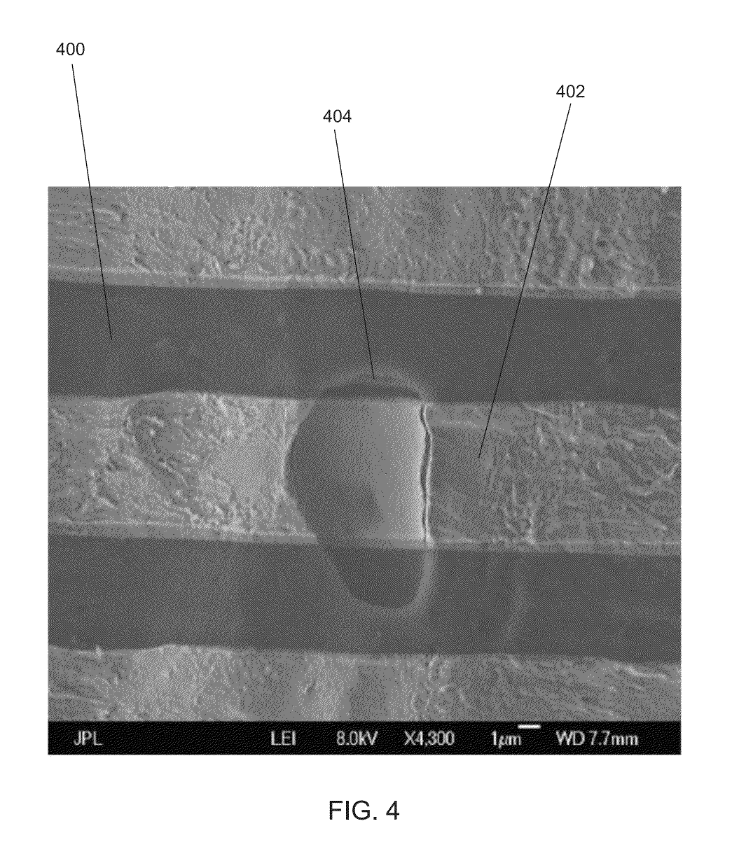

Importantly, it should be noted that LCP can have a surface roughness on the order of several micrometers (root mean square [r.m.s.]). Such surface roughness values can promote undesired delamination between the LCP substrate and components disposed thereon. For example, FIG. 4 depicts how the surface roughness of the underlying LCP substrate can cause delamination of the conductive elements of a sensor that are thereon disposed. In particular, a conductive element (platinum) of a sensor 402 is disposed on an underlying LCP substrate 400. The surface roughness of the underlying substrate undesirably causes delamination as seen in a region 404 of the illustration. In view of this possibility, care must be taken to sufficiently adhere any thereon disposed components such that instances of delamination can be reduced.

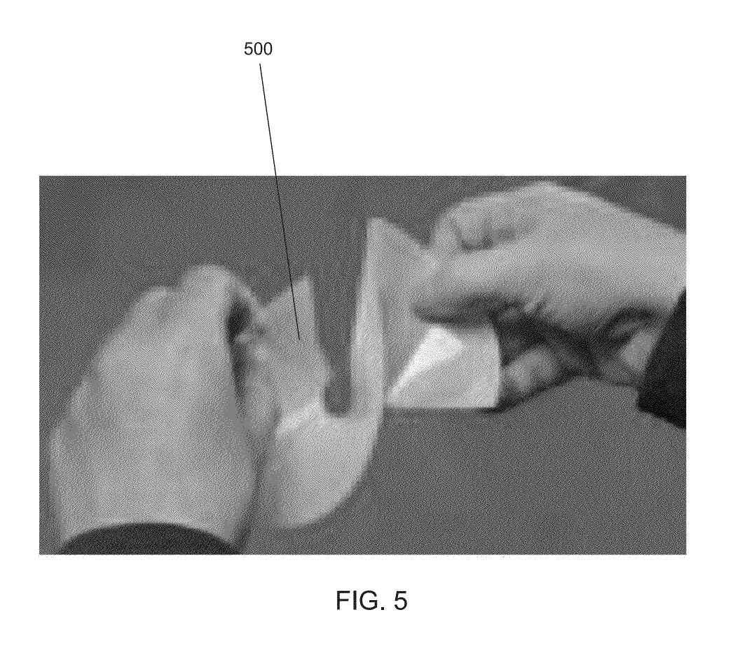

In a number of embodiments, an integrated environmental sensor includes 3YSZ as the substrate upon which sensors are disposed. 3YSZ is advantageous insofar as it has been demonstrated to be tolerant of a wide variety of rigorous environmental conditions. Further, 3YSZ is relatively smooth as compared with LCP (r.m.s. of 20 nm), is compatible with temperatures as high as 800° C., has an ionic conductivity of 0.03 S/cm at 800° C., and has a strength of 1 GPa. Additionally, 3YSZ has sufficient flexibility that can allow it to be compatible with sensing mechanisms that rely on such flexibility. For example, FIG. 5 illustrates the flexibility of the 3YSZ material. In particular, the illustration is similar to that seen in FIG. 2 insofar as it depicts the flexibility that 3YSZ can be made to obtain—a 3YSZ substrate is depicted being subjected to substantial strain, yet the substrate maintains its integrity. 3YSZ is also beneficial insofar as it is compatible with the above-described thermal spray patterning technique. Note that the described substrate materials can be of any suitable thickness. In many embodiments, a 3YSZ substrate material having a 40 μm thickness is incorporated in integrated environmental sensors.

3YSZ substrates, may however be susceptible to cracking if, for example, subjected to a direct, head on, flow. This can be due to relatively brittle nature of the material. For example, if the substrate is subjected to a flow, e.g. an oil flow, the flow may cause the fracturing of the substrate. Accordingly, in many embodiments, steps are taken to mitigate this result. For example, in some embodiments, a coating layer is added to deter any potential brittle fracture. Any supportive layer can also be incorporated.

In a number of embodiments, Inconel is used as the material from which to form the substrate. The Inconel can be coated with a dielectric material to provide an electrical isolation from any thereon disposed sensing elements. Inconel is advantageous insofar as it is relatively less brittle than, for example, 3YSZ.

Of course it should be understood that while several suitable materials that can be used to develop substrates have been discussed, any of a number of materials can be used from which to fabricate substrates in accordance with embodiments of the invention. For example, in some instances, composite materials can be used, e.g. combinations of metal layers, ceramic layers, and polymer layers can be adjoined to form a substrate. Thus, metal foils that include layers of ceramic can be used as a substrate material. The supplementing layers in a composite material can provide structural reinforcement for the substrate. Additionally, the substrate, as well as any thereon disposed sensors can be coated with a protective layer to further protect the integrated environmental sensor from harmful environmental conditions.

The sensors can that be disposed on the substrate for sensing environmental conditions are now discussed below.

### Flow Rate Sensors

Any of a variety of sensors can be incorporated in an integrated environmental sensor in accordance with embodiments of the invention. In many embodiments, sensors that can determine the rate of flow of surrounding fluids can be incorporated within an integrated environmental sensor, and any of a variety of such flow rate sensors can be incorporated. In many embodiments, flow rate sensors rely on the force of the surrounding fluid to cause movement of their respective elements where the extent of the movement can be correlated with the rate of flow. For instance, in many embodiments, a flow rate sensor includes an element that is configured to protrude into a flow, and thereby be impacted by the flow. For instance, FIG. 6 illustrates flow rate sensors submerged in a flow within a pipeline. In particular, a plurality of flow rate sensors 600 are depicted as being submerged in a flow; the flow rate sensors include an element that protrudes into the flow such that the force of the flow causes the movement of the protruding element 602. Accordingly, the movement of the protruding element can be correlated to the rate of the impacting flow using any of a variety of techniques.

For example, in some embodiments, strain gauge-based flow rate sensors are incorporated in an integrated environmental sensor. Strain gauge-based flow rate sensors rely on the force of a flow to strain a protruding element; the extent of the strain can be correlated with the rate of flow of the fluid. For example, the strain gauge-based flow rate sensor can include a conductive element that when stretched will change its resistivity. Typically, the conductive element is disposed on a substrate, and is coupled to it. In general, strain gauge behavior can be summarized by:

$$\frac{Δ R}{R} = G \cdot ɛ$$

$$ɛ = \frac{σ}{E} = \frac{Δ l}{l}$$

where
R is the resistance of the resistor in the strain gauge;
G is a gauge factor;
∈ is strain;
σ is axial load (pressure);
E is young's modulus; and
l is the length of the strain gauge.

Accordingly, in many embodiments, a strain gauge-based flow rate sensor is designed in view of the expected fluid flow in the environment to be investigated. For instance, the material of the protruding element can be chosen such that the fluid flow will cause a measurable strain. Thus, for example, where the sensor is expected to operate in an environment that includes a flowing dense liquid, then a flow rate sensor including a relatively more rigid protruding element that can withstand the force of the fluid but at the same time deflect to a measurable extent can be implemented. Conversely, where the sensor is anticipated to operate in an environment that includes a flowing lighter fluid, then a correspondingly less rigid protruding element can be implemented. Table 1 below lists some typical gauge factors.

TABLE 1
Typical Gauge Factors

| Material | Gauge Factor |
|---|---|
| Metal foil strain gauge | 2-5 |
| Thin-film metal | 2 |
| Single crystal silicon | −125 to 200 |
| Polysilicon | ±30 |

Table 2 lists typical Young's Modulus Values.

TABLE 2
Typical Young's Modulus Values

| Material | E (GPa) |
|---|---|
| PTFE (Teflon) | 0.5 |
| Aluminum | 69 |
| Glass | 50-90 |
| Single crystal silicon | ~150 |
| Steel | 200 |
| Inconel | 208 |

Of course it should be understood that although several materials from which protruding elements including conductive elements are listed, any of a variety of materials can be incorporated to fabricate a strain gauge-based flow rate sensor in accordance with embodiments of the invention. For instance, in many embodiments, a strain gauge-based flow rate sensor includes an element configured to protrude into a flow that is fabricated from 3YSZ and that includes a platinum conductive element disposed thereon. The resistance of the platinum can be correlated with the extent to which it is strained. In many instances the conductive element is in the shape of a serpentine pattern so as to maximize the change in resistance due to strain.

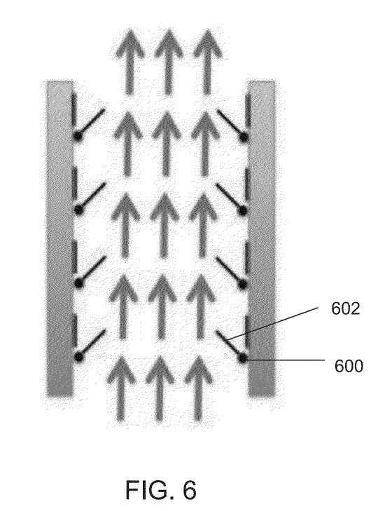

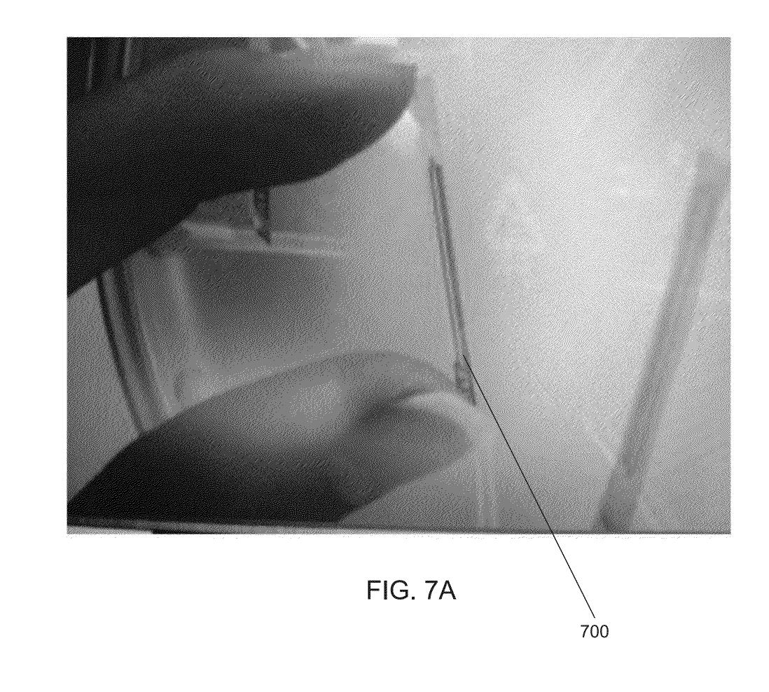

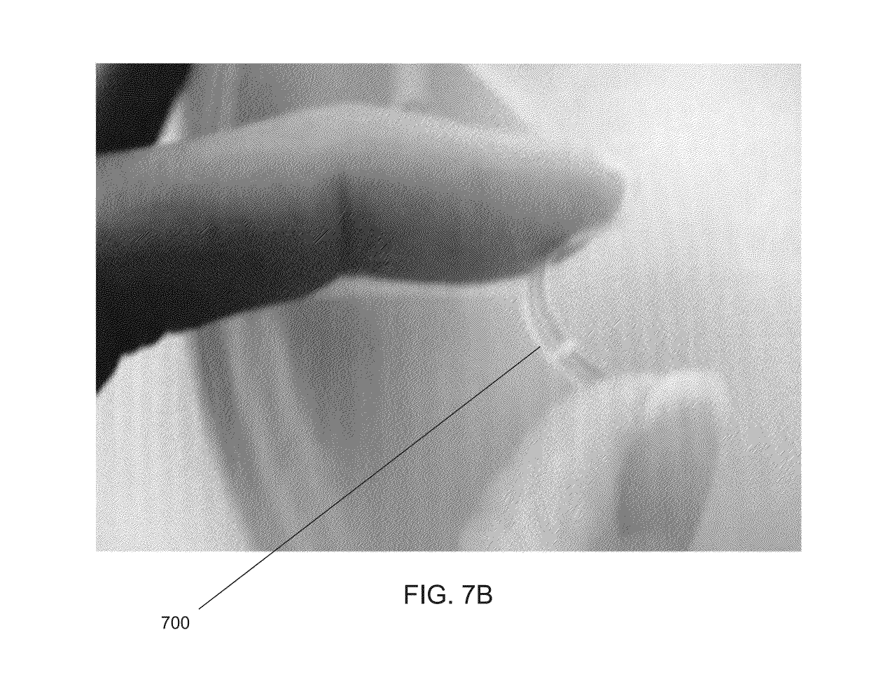

FIGS. 7A and 7B depict a strain gauge-based flow rate sensor that includes a platinum conductive element disposed on a 3YSZ substrate. In particular, FIG. 7A depicts the protruding element 700 in its relaxed state, while FIG. 7B depicts the protruding element 700 in its flexed state. The flexing of the element, e.g. resulting from the force of a fluid flow, will cause it to strain to an extent correlated with the rate of flow).

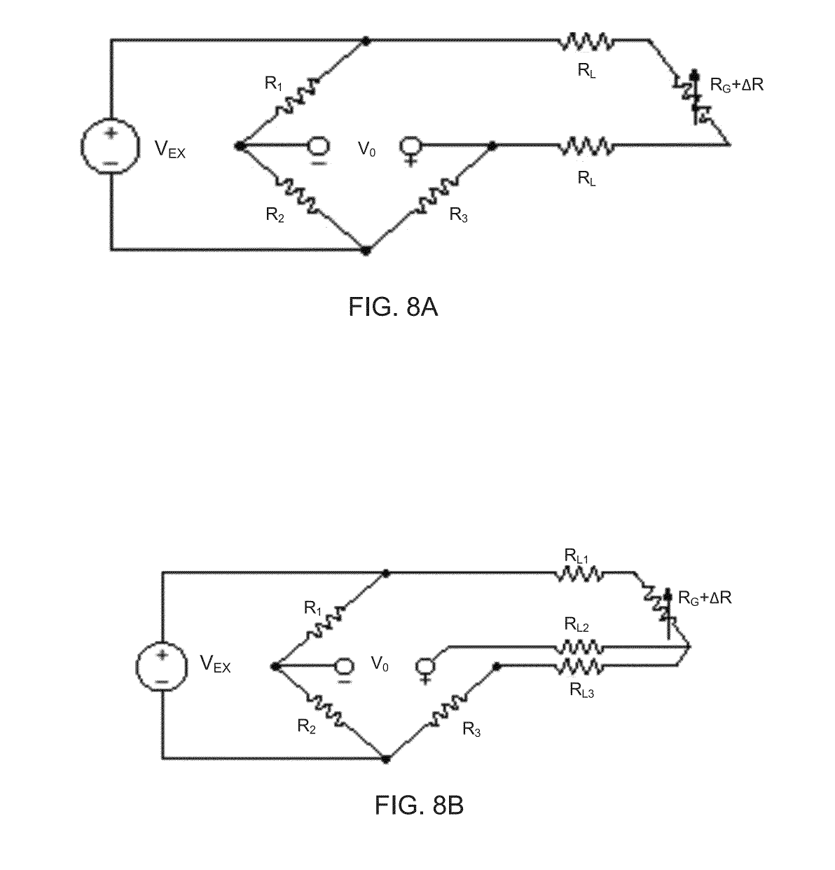

The resistance of the conductive element can be determined in any suitable way in accordance with embodiments of the invention. For example, in many embodiments, the conductive element is coupled to a Wheatstone bridge that can be used to determine the resistance. As can be appreciated, Wheatstone bridges can be used to readout resistance values from any of a variety of sensors in accordance with embodiments of the invention. FIGS. 8A-8B depict schematics of Wheatstone Bridges that can be incorporated in accordance with embodiments of the invention. In particular, FIG. 8A depicts a two-wire Wheatstone bridge configuration, while FIG. 8B depicts a three-wire Wheatstone bridge configuration. To be clear, although Wheatstone bridges are discussed, any suitable circuitry can be incorporated to read out resistance values of the sensors in accordance with embodiments of the invention.

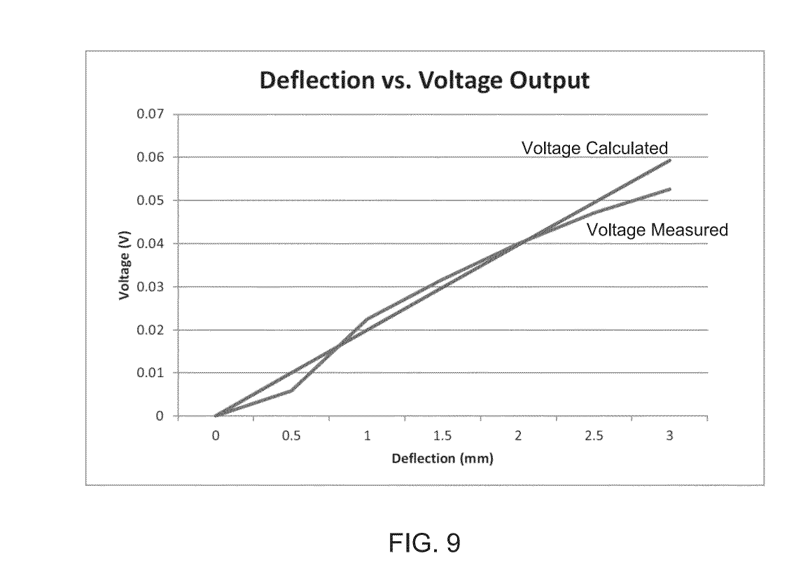

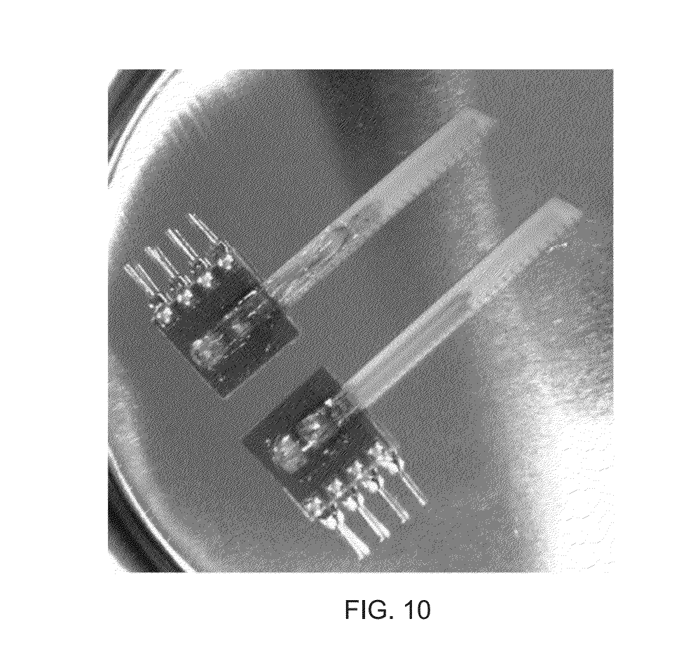

In many instances, strain gauge-based flow rate sensors are calibrated so that the correlation between strain and rate of flow can be better established. Generally, any suitable calibration techniques can be implemented. For instance, the sensors can be calibrated by imposing a known flow rate onto the sensor and measuring the electrical characteristics of the conductive element as it is strained. For example, FIG. 9 depicts a calibration curve that was developed for a 10 mm long platinum conductive element. In particular, the curve indicates that a greater deflection resulted in a greater voltage. As can be appreciated, the extent to which the flow rate sensor deflects can thereby be correlated with the corresponding rate of flow. FIG. 10 depicts a fully fabricated strain-gauge based flow rate sensor, including readout circuitry, in accordance with embodiments of the invention.

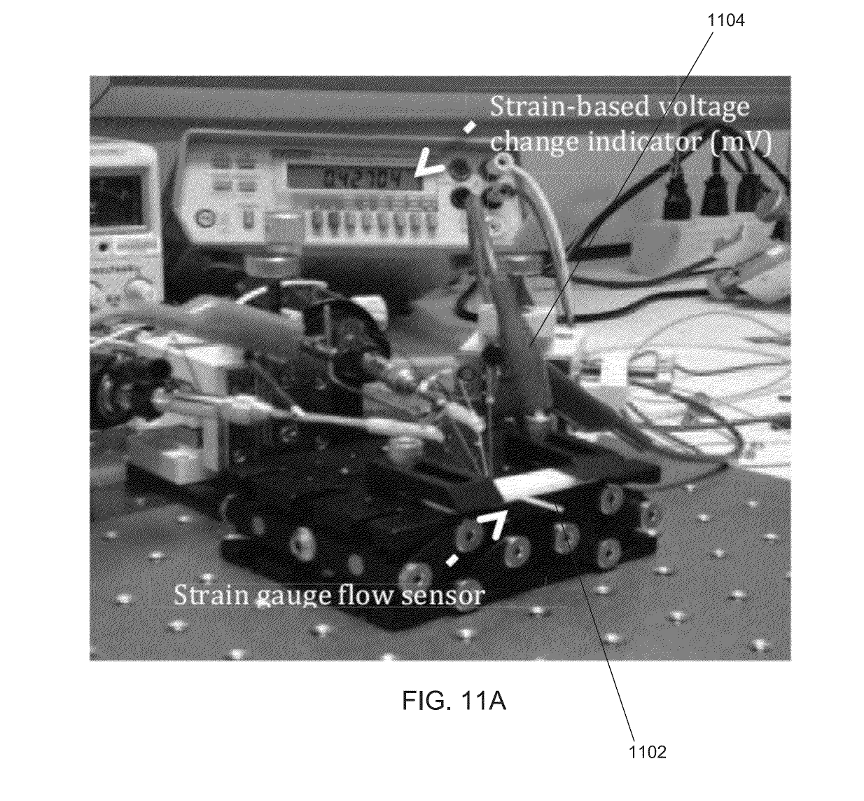

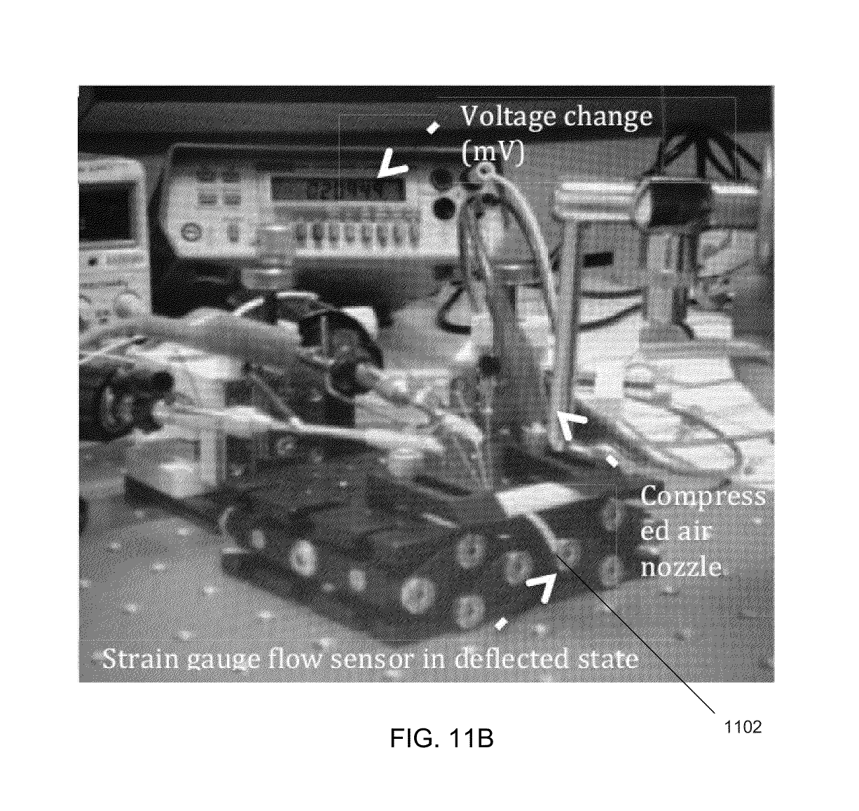

FIGS. 11A and 11B illustrate a testing apparatus that can be used to demonstrate the viability of a flow rate sensor. In particular, FIG. 11A depicts the setup that includes the strain gauge-based flow rate sensor 1102 as well as a compressed air nozzle 1104 that subjects the strain gauge-based flow rate meter to a flow. The setup allows the strain gauge-based flow rate meter to be read out while being subjected to the air flow. FIG. 11B depicts the strained strain-gauge based flow rate sensor 1102 as it is subjected to the air flow. Note that the illustrations show that the reading on the volt meter has changed indicating the functionality of the flow rate sensor.

While strain gauge-based flow rate sensors have been discussed, it should be clear that any of a variety of flow rate sensors can be incorporated in integrated environmental sensors in accordance with embodiments of the invention. Indeed any type of sensor can be integrated in accordance with embodiments of the invention. In many embodiments, capacitance-based flow rate sensors are incorporated. Capacitance-based flow rate sensors are similar to the strain-gage based sensors described above except that they are configured such that the subject flow causes a gap between two constituent electrodes to vary, such that the capacitance between the two electrodes is correspondingly varied. In essence, the extent to which the gap varies can be correlated with the force of the flow, and correspondingly the rate of flow. Recall that the capacitance between two electrodes separated by a gap can generally be characterized using the relationship:

$$C = \frac{{ɛ}_{0} \cdot {ɛ}_{r} \cdot A}{d}$$

### Where

∈₀=permittivity of free space=8.854e-12 [F·cm-1]
∈ᵣ=Relative permittivity (material specific)
A=Overlapping Area of the electrodes (cm²)
d=separation distance [cm]

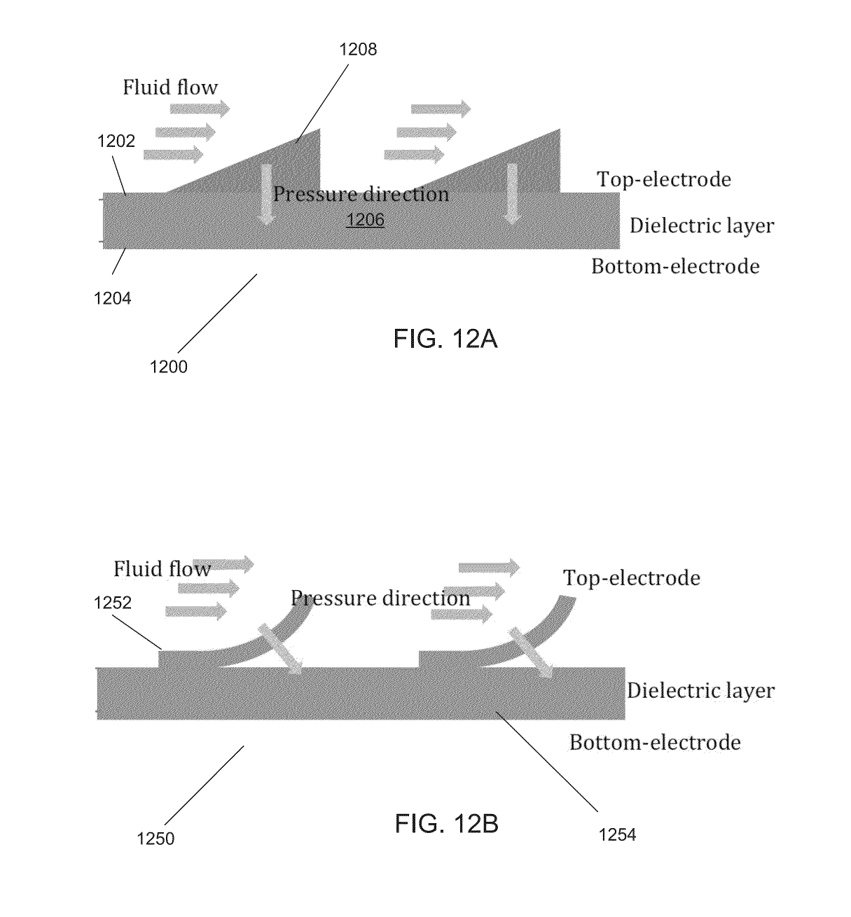

Accordingly, in many embodiments, a capacitance-based flow rate sensor includes a stationary electrode and a movable electrode, such that the distance between the electrodes can be made to vary under the influence of flow. FIGS. 12A and 12B depict two examples of capacitance-based flow rate sensors in accordance with embodiments of the invention. In particular, FIG. 12A depicts a capacitance-based flow rate sensor 1200 including a top electrode 1202 and a bottom electrode 1204 separated by a dielectric layer 1206. As can be appreciated, the dielectric layer 1206 can be any suitable material, and can even be vacated, in accordance with embodiments of the invention. The top electrode is coupled with protruding elements 1208 that are adapted to protrude into a flow such that when the sensor 1200 is immersed in a flow, the flow imposes a force—corresponding to the rate of flow—onto the protruding elements 1208, which thereby drive the top electrode 1204 towards the bottom electrode 1202. Accordingly, the gap between the two electrodes decreases, and correspondingly causes the capacitance between the two electrodes to increase. In this way, the rate of the flow can be associated with the capacitance, which can be measured using any of a variety of conventional techniques.

FIG. 12B depicts a similar capacitance-based flow rate sensor, except that the top electrodes themselves are adapted to protrude into the flow. In particular, it is illustrated that the capacitance-based flow rate sensor includes top electrodes 1252 that curve away from the bottom electrode 1254 and can thereby protrude into a flow. Accordingly, as before, the flow imposes a force that drives the top electrodes toward the bottom electrode; the decrease in the gap between the top and bottom electrodes results in a change in capacitance, and the capacitance can be correlated with the rate of flow.

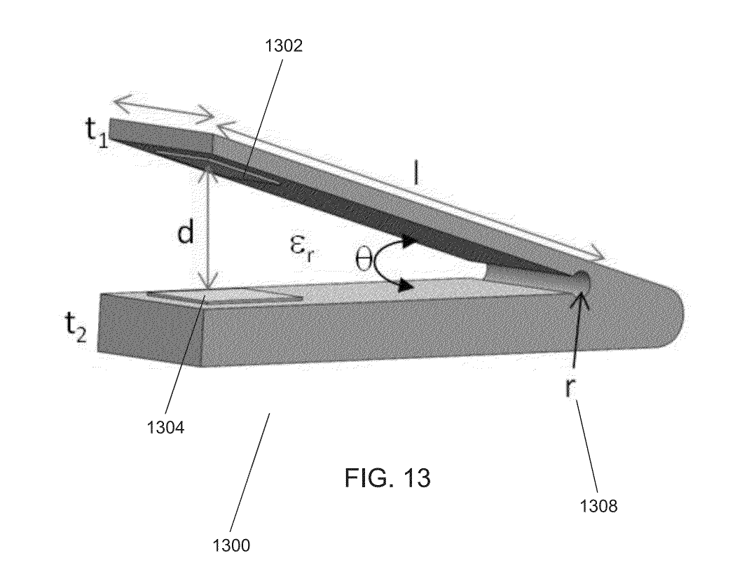

While FIGS. 12A-12B depict two designs for capacitance based sensors, it should be clear that any of a variety of configurations can be incorporated to implement capacitance-based flow rate sensors. For example, FIG. 13 depicts a V-shaped Flow-rate sensor that generally operates in accordance with the principles discussed above. In particular, as before, the capacitance-based flow rate sensor 1300 includes a top electrode 1302 and a bottom electrode 1304 separated by a gap. However, in the V-shaped flow rate sensor 1300, the top electrode 1302 and bottom electrode 1304 are coupled to a structure that includes a flexure joint region 1308 that allows the distance between the top electrode and bottom electrode to vary. Note that the illustration depicts some of the design parameters that can be varied in accordance with embodiments of the invention. For example, the thickness (t₁ and t₂) and length (l) of the structural elements, the default distance between the electrodes (d), the default angle (θ) between the elongated portions of the V-shaped structure, and the radius (r) of the flexural joint region can be varied to achieve any of a variety of configurations in accordance with embodiments of the invention. Again, to be clear, any of a variety of configurations can be implemented to effectuate capacitance-based flow rate sensors in accordance with embodiments of the invention.

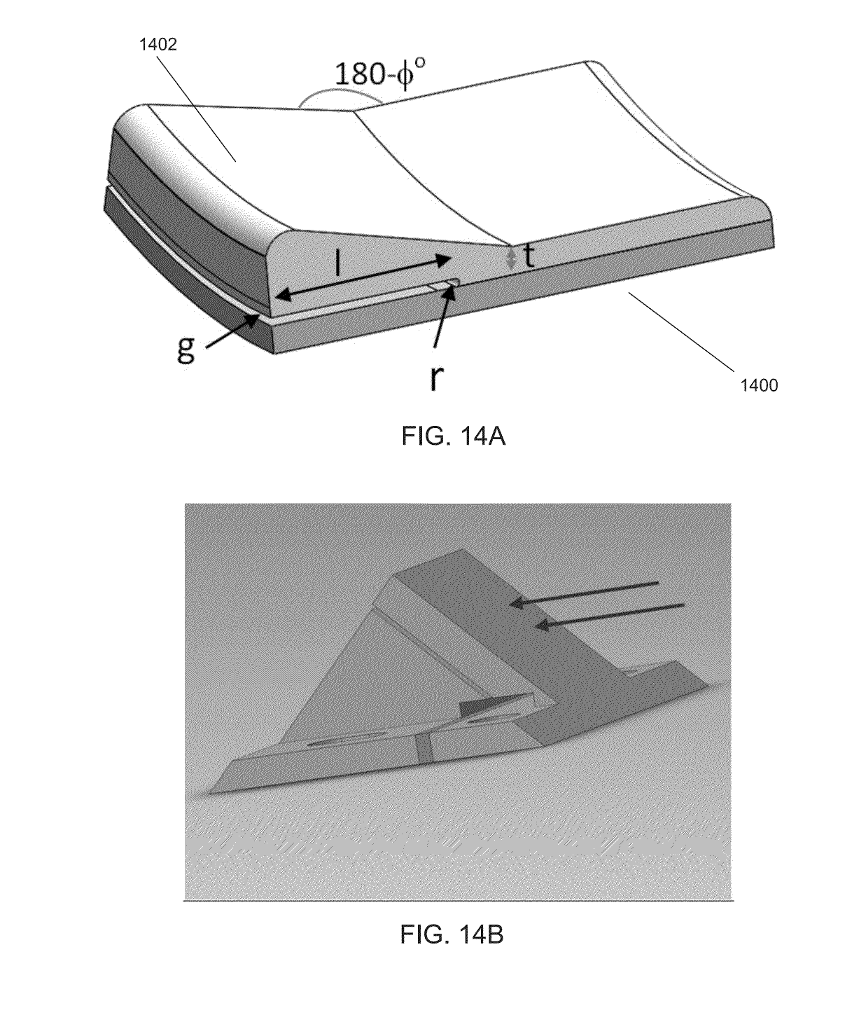

FIGS. 14A-14B depict yet further examples of capacitance-based flow rate sensors that can be implemented in accordance with embodiments of the invention. In particular, FIG. 14A depicts a capacitance-based flow rate sensor configuration 1400 that includes a cantilever type region 1402. As can be appreciated, the illustrated flow rate sensor operates in accordance with the same principles established above. Also, as before, the illustration depicts some of the parameters that can be varied to achieve further configurations in accordance with embodiments of the invention; for example, it is illustrated that the thickness (t) of the structural portion, the length (l) of the gap portion, the default distance of the gap portion (g), the radius (r) of the adjoining region, and the angle of the protruding portion of the structure (180°−φ) can vary. FIG. 14B depicts a configuration whereby the electrodes are embedded within a structure shaped like a triangular prism. In the illustrated embodiment, the electrodes are oriented such that the force of the flow more directly causes the distance in the gap to decrease. While various configurations of flow rate sensors that can be incorporated in integrated environmental sensors are illustrated, it should be clear that any of a variety of different types of sensors can be incorporated. Below, it is discussed how temperature sensors can be incorporated in accordance with embodiments of the invention.

### Temperature Sensors

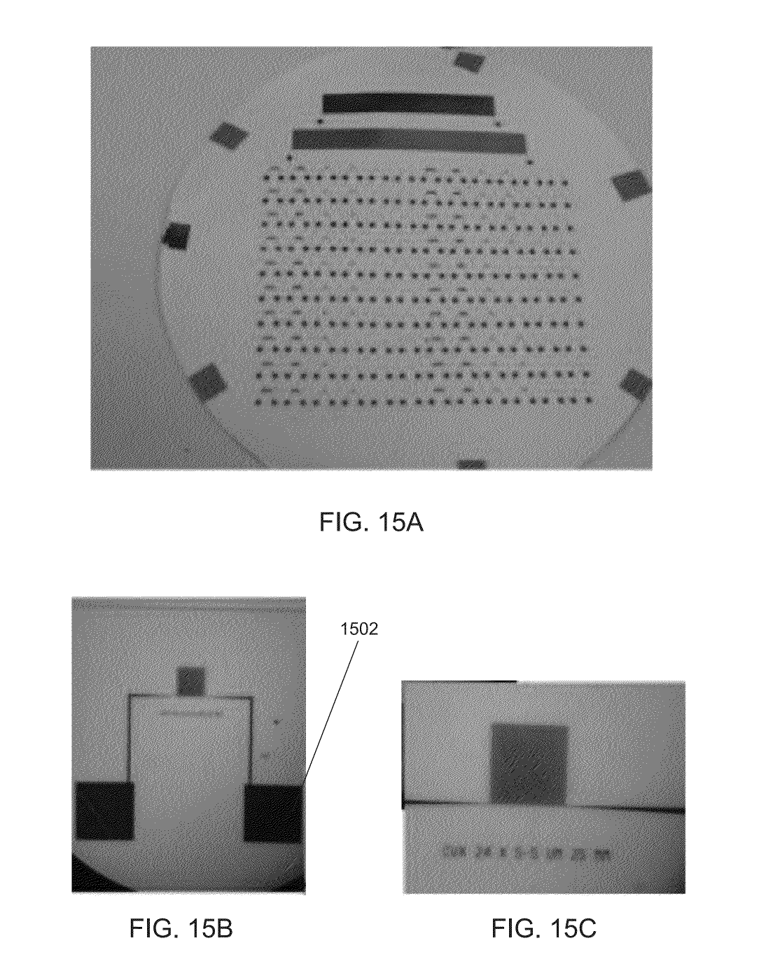

In many embodiments of the invention, sensors that can measure the temperature of the surrounding environment are incorporated within integrated environmental sensors. Any type of temperature sensor can be incorporated. For instance, in many embodiments, resistance temperature detectors (RTDs) are incorporated. Resistance temperature detectors are typically characterized in that they include a conductive element disposed on a substrate, where the resistance of the conductive element is a function of the temperature of the surrounding environment. Accordingly, the resistance of the conductive element can be measured (e.g. using a Wheatstone bridge) to determine the temperature of the surrounding environment. In many instances, the conductive element adopts a serpentine shape. A serpentine shape is beneficial as it exaggerates the dependence of the conductive element's resistance on temperature. Note that typically, conductive elements that have wider cross-sections have relatively reduced resistance values. Of course, as can be appreciated, the conductive material and the substrate can be made of any suitable material. For example, the conductive element can be made of platinum (e.g. platinum having a resistivity of 105 nΩ·m), and the substrate can be made of one of LCP and 3YSZ. FIGS. 15A-15C illustrate RTDs that include platinum conductive elements disposed on an LCP substrate. In particular, FIG. 15A depicts the RTDs manufactured on a substrate in bulk, FIG. 15B depicts a close up of a single RTD, and FIG. 15C depicts a close up of the serpentine structure. Note that FIG. 15B the contact pads 1502, from which the resistivity of the conductive element can be read out are depicted. In the illustration, the conductive element has a width of 5 μm and a spacing of 5 μm.

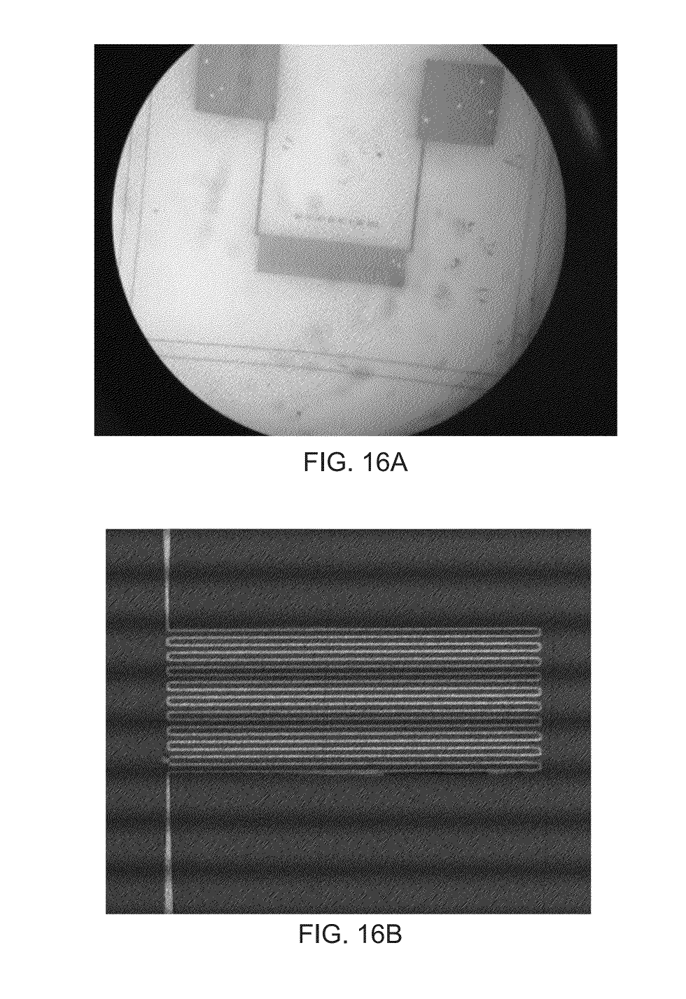

Similarly, FIGS. 16A-16B illustrates an RTD that includes a platinum conductive element disposed on a 3YSZ substrate. In particular, FIG. 16A depicts the RTD, while FIG. 16B depicts a close up of the serpentine structure. Although several RTD configurations are shown, any of a variety of RTD configurations can be implemented. Additionally, the RTDs can be fabricated from any suitable materials in accordance with embodiments of the invention.

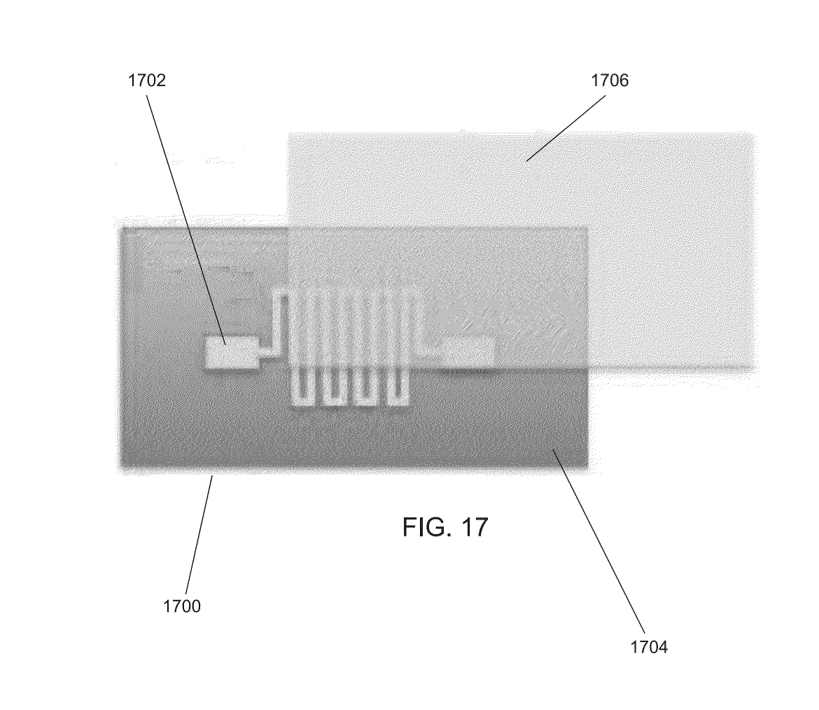

In many embodiments, the RTDs are coated with a coating layer that serves to protect it from the surrounding environment. For instance, the coating layer can protect the RTD from environmental conditions that are characterized by one of: the temperature is greater than or equal to approximately 150° C.; the pressure is greater than or equal to 100 bar; and the environment is corrosive—e.g. it includes one of liquid hydrocarbons, H₂S, CO₂, and sulfur species. Generally, any of the sensors described in this application can be coated with such a protective layer. FIG. 17 diagrams a RTD coated with a coating layer in accordance with embodiments of the invention. In particular, an RTD 1700 that includes a conductive element 1702 adopting a serpentine shape deposited on a substrate 1704 is shown being coated with a protective coating layer 1706.

As can be appreciated, the resistance of the conductive element can generally vary linearly in proportion to the temperature. Calibration curves can be established for RTDs to facilitate their accuracy. In many embodiments, RTDs that can determine temperature to an accuracy of within 5% are incorporated within an integrated environmental sensor in accordance with embodiments of the invention. Indeed, in many embodiments, only sensors (e.g. sensors for measuring flow rate, temperature, composition, and/or pressure) that can measure respective environmental parameters within an accuracy of at least 5% are incorporated within an integrated environmental sensor.

While the above description has largely regarded RTDs, any sensor for determining the temperature of the surrounding environment can be incorporated in an integrated environmental sensor in accordance with embodiments of the invention. In many embodiments, sensors for determining the composition of the surrounding environment are incorporated, and these sensors are now discussed below.

### Composition Sensors

In many embodiments, sensors for measuring composition are incorporated in integrated environmental sensors. Any sort of compositional sensor can be incorporated. For instance, in many embodiments, composition sensors that function based on the principles of dielectric spectroscopy are incorporated. Generally, composition sensors based on dielectric spectroscopy include two electrodes separated by a gap that is exposed to the environment to be investigated. The capacitance between the two electrodes changes as a function of the composition of the gap between the two electrodes. In other words, the dielectric constant of the gap will be a function of the composition within the gap. For example, where the sensor is immersed in a fluid, the capacitance between the two electrodes—which can be measured—will be a function of the dielectric constant of the fluid that fills the gap between the two electrodes. By measuring the capacitance, the dielectric constant can be determined, and correspondingly, the fluid composition can be inferred. For example, the dielectric constant of salt water is on the order of 2, whereas the dielectric constant of oil is on the order of 80. Accordingly, composition sensors based on dielectric spectroscopy can be very sensitive. The electrodes of such sensors can adopt any suitable shape and can accommodate many designs. In many instances, the electrodes are coated with a passivation layer that can protect them from harmful environmental conditions (e.g. temperatures greater than 150° C., pressures greater than 100 bar, and corrosive environments—e.g. those including one of liquid hydrocarbons, H₂S, CO₂, and sulfur species).

In many embodiments, sensors that detect the ambient pressure of the surrounding environment are incorporated within an integrated environmental sensor, and these sensors are now discussed below.

### Pressure Sensors

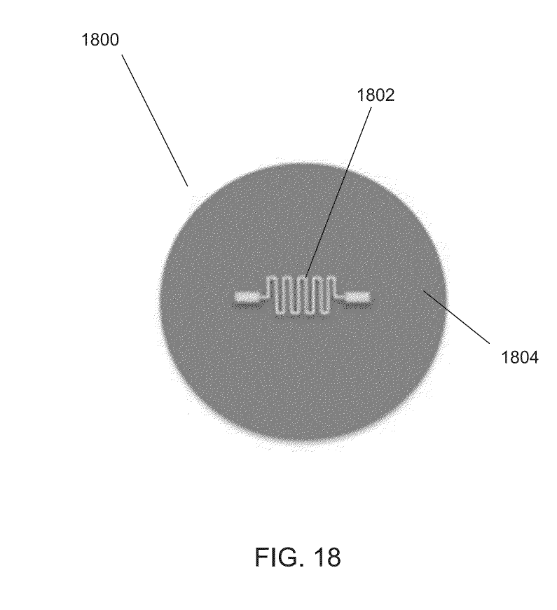

In many embodiments, sensors that can detect the ambient pressure of the surrounding environment are incorporated within an integrated environmental. Any type of such a pressure sensor can be incorporated. For instance, pressure sensors that rely on an acoustic technique where a quartz resonator is used to detect the resonance frequency shift due to changes in pressure may be incorporated. In some embodiments, pressure sensors are incorporated that rely on a movable element that moves in relation to the applied pressure. The motion can be detected either measuring the strain of the element component or the capacitance between an electrode on the moved and a stationary electrode (these principles are similar to those seen with respect to the flow rate sensors described above). FIG. 18 depicts a strain gauge-based pressure sensor in accordance with embodiments of the invention. In particular, the strain gauge sensor 1800 includes a conductive element 1802 disposed on a substrate 1804. When pressure is applied—e.g. ‘into the page’—the conductive element is strained which impacts its resistance (which is measurable). Accordingly, the resistance can be measured and correlated with the ambient pressure. As before, the conductive element 1802 can adopt a serpentine shape, that exaggerates the strain and thereby can make the pressure sensor more sensitive.

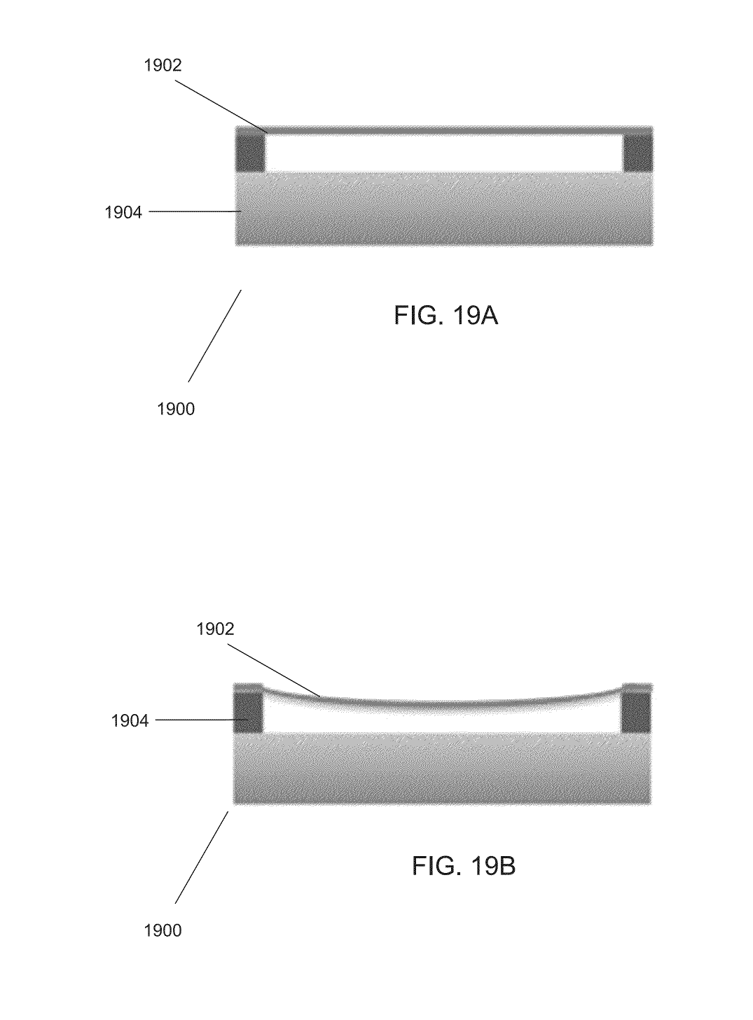

FIGS. 19A-19B depict a capacitance-base pressure sensor. In particular, FIG. 19A depicts the capacitance-based pressure sensor 1900 in its default state. The sensor 1900 includes a top electrode 1902 and a bottom electrode 1904 separated by a gap. When, the gap distance between the top electrode 1902 and the bottom electrode 1904 can be a function of the ambient pressure (e.g. more pressure may force the top electrode and bottom electrode closer together). Accordingly, as the gap distance is a function of ambient pressure, the capacitance is a function of the ambient pressure, and thus the ambient pressure can be determined by measuring the capacitance. FIG. 19B depicts the capacitance-based pressure sensor 1900 subject to high pressures and thereby in a flexed state. In the illustration, the gap between the top electrode 1902 and the bottom electrode 1904 is decreased, so the capacitance is made higher; the higher capacitance indicates a higher pressure.

### Integration of Sensors

While the above description has regarded several types of sensors, it should be clear that any type of sensors can be incorporated in an integrated environmental sensor in accordance with embodiments of the invention. Additionally, any of a variety of protection mechanisms for protecting the sensors from harsh environmental conditions can be incorporated. For instance, as mentioned above, coating layers can be applied to protect the sensors. In some embodiments, the constituent materials of the sensors are such that the sensors. For instance, 3YSZ can withstand temperatures as high as 800° C. Accordingly, in many embodiments, the sensors are fabricated from robust materials. Importantly, where the incorporated sensors rely on similar principles, the implemented readout circuitry can be simplified. Thus, for example, where an integrated sensor includes a strain gauge-based flow rate sensor and a strain gauge-based pressure sensor, the readout circuitry required for the integrated environmental sensor can be consolidated as it only needs to correlate the resistance of the respective conductive elements with the respective environmental parameters. Note also that, in some embodiments a single sensor can communicate multiple environmental parameters. For instance, a single conductive element can communicate temperature as well as flow rate—in this case, the conductive element will be acting as part of a strain gauge based flow rate sensor as well as part of an RTD. In these instances the total strain of the conductive element will be partly attributed to the temperature and partly attributed to the rate of flow of a surrounding fluid. These constituent components of the total strain can be decoupled using any suitable technique such that the conductive element can measure both environmental properties.

In many embodiments, integrated environmental sensors include multiple of the same type of sensor, wherein each of the same type of sensor is configured to better measure certain ranges of a given environmental parameter. For example, in some embodiments, an integrated environmental sensor includes a flow rate sensor adapted for measuring a fluid having a high rate of flow, and also includes a flow rate sensor adapted for measuring a fluid having a lower rate of flow. In general any number and any variety of sensors can be incorporated within an integrated environmental sensor in accordance with embodiments of the invention.

As can be inferred from the above discussion, the above-mentioned concepts can be implemented in a variety of arrangements in accordance with embodiments of the invention. Accordingly, although the present invention has been described in certain specific aspects, many additional modifications and variations would be apparent to those skilled in the art. It is therefore to be understood that the present invention may be practiced otherwise than specifically described. Thus, embodiments of the present invention should be considered in all respects as illustrative and not restrictive.

What claimed is:

1. An integrated environmental sensor comprising:
at least one sensor; and
a substrate;
wherein:
the at least one sensor is disposed on the substrate;
the at least one sensor can detect at least two environmental properties that are each one of: the temperature of the environment surrounding the substrate; the pressure of the environment surrounding the substrate; the rate of flow of fluids in the environment surrounding the substrate; and the composition of matter in the environment surrounding the substrate;
the at least one sensor is capable of detection in an environment characterized by at least one of: a temperature greater than or equal to approximately 150° C.; a pressure greater than or equal to approximately 100 bar; an inclusion of one of liquid hydrocarbons, H₂S, CO₂, and sulfur species; and
the substrate can withstand an environment characterized by at least one of: a temperature greater than or equal to approximately 150° C.; a pressure greater than or equal to approximately 100 bar; an inclusion of one of liquid hydrocarbons, H₂S, CO₂, and sulfur species.

2. The integrated environmental sensor of claim 1 wherein the at least one sensor is at least two sensors.

3. The integrated environmental sensor of claim 2, wherein the at least two sensors can detect the at least two environmental properties to an accuracy of within approximately 5%.

4. The integrated environmental sensor of claim 3, wherein the substrate comprises Yttria-Stabilized Zirconia.

5. The integrated environmental sensor of claim 4, wherein the substrate comprises 3 mol % Yttria-Stabilized Zirconia (3YSZ).

6. The integrated environmental sensor of claim 5, wherein the substrate is 40 μm in thickness.

7. The integrated environmental sensor of claim 5, wherein the substrate has a surface roughness characterized by 20 nm root mean square, can withstand 800° C., has an ionic conductivity at 800° C. of 0.03 S/cm, and has a strength of 1 GPa.

8. The integrated environmental sensor of claim 3, wherein at least one sensor is a resistance temperature detector, the resistance temperature detector comprising a conductive element wherein the electrical resistance of the conductive element is a function of the temperature of the environment surrounding the substrate.

9. The integrated environmental sensor of claim 8, wherein the conductive element of the resistance temperature detector is platinum.

10. The integrated environmental sensor of claim 9, wherein the platinum has an electrical resistivity of approximately 105 nΩ·m.

11. The integrated environmental sensor of claim 8, wherein the resistance temperature detector further comprises a protective coating that protects it from the environment surrounding the substrate.

12. The integrated environmental sensor of claim 8, wherein the coefficient of thermal expansion of the substrate and the coefficient of thermal expansion of the resistance temperature detector are sufficiently similar such that the conductive element does not exhibit any stress induced fractures when the temperature surrounding the substrate elevates to 300° C.

13. The integrated environmental sensor of claim 8, wherein the resistance temperature detector further comprises Wheatstone bridge readout circuitry.

14. The integrated environmental sensor of claim 3, wherein at least one sensor is a flow rate sensor that can measure the rate of flow of fluids in the environment surrounding the substrate.

15. The integrated environmental sensor of claim 14, wherein the flow rate sensor is a strain gauge-based flow rate sensor that comprises a conductive element configured such that when the flow rate sensor is exposed to a flow, the conductive element is strained to an extent that is related to the rate of flow, and the electrical resistance of the conductive element is a function of the extent to which it is strained.

16. The integrated environmental sensor of claim 15, wherein:
the substrate is one of: PTFE (Teflon); aluminum; glass; single crystal silicon; Steel; and Inconel; and
the conductive element comprises one of: metal foil; thin-film metal; single crystal silicon; and polysilicon.

17. The integrated environmental sensor of claim 15, wherein the substrate is 3YSZ and the conductive element is platinum.

18. The integrated environmental sensor of claim 17, further comprising a Wheatstone bridge coupled to the conductive element.

19. The integrated environmental sensor of claim 14, wherein the flow rate sensor is a capacitance-based flow rate sensor that comprises two electrodes separated by a gap and configured such that when the flow rate sensor is exposed to a flow, the gap distance between the two electrodes changes in relation to the rate of flow, and the capacitance between the two electrodes is a function of the gap distance.

20. The integrated environmental sensor of claim 3, wherein at least one sensor is a composition sensor that can detect the composition of the surrounding environment comprising two electrodes separated by a gap, wherein the capacitance between the two electrodes changes as a function of the composition of the gap.
